(19) United States
(12) Patent Application Publication
(10) Pub. No.: US 2026/0242529 A1
(43) Pub. Date: Aug. 20, 2026

(54) POLYURETHANE UREA AND ITS PREPARATION METHOD

(71) Applicant: BASF SE, Ludwigshafen am Rhein (DE)

(72) Inventors: Xiu Juan Zhang, Shanghai (CN); Da Shi, Shanghai (CN); Ming Qian Zhou, Shanghai (CN); Dian Bo Jiang, Shanghai (CN)

(73) Assignee: BASF SE, Ludwigshafen am Rhein (DE)

(21) Appl. No.: 18/843,810

(22) PCT Filed: Mar. 2, 2023
(86) PCT No.: PCT/EP2023/055261

§ 371 Date: Sep. 4, 2024

(30) Foreign Application Priority Data
Mar. 10, 2022 (WO) PCT/CN2022/080148

(51) Int. Cl. C08G 18/32; C08G 18/10; C08G 18/28; C08G 18/48; C08G 65/332; D01D 1/02; D01D 1/06; D01D 5/00

(52) U.S. Cl. CPC C08G 18/324; C08G 18/10; C08G 18/2865; C08G 18/3228; C08G 18/4854; C08G 65/3326; D01D 1/02; D01D 1/065; D01D 5/0038; C08G 2650/02; D10B 2331/10; D10B 2331/12; D10B 2401/061

(57) ABSTRACT

A polyurethane urea synthesized in a preparation method shows a low modulus, high elongation and good heat-resistance. The polyurethane urea is prepared by a) reacting modified PolyTHF and diisocyanate to obtain a prepolymer, b) adding chain extender and optionally chain terminator into said prepolymer to obtain a polyurethane urea solution, and c) spinning or casting the solution obtained in b) to obtain the polyurethane urea.

### TECHNICAL FIELD

The present invention relates to a polyurethane urea and its preparation method. It further relates to a low modulus, high elongation and good heat-resistance polyurethane urea fiber or film produced from modified PolyTHF, isocyanate, chain extender and if appropriate chain terminator.

### BACKGROUND

Commercial polyurethane urea fiber, i.e., spandex fiber, is produced via a process comprising: a) reacting polymeric glycol or polyol with isocyanate to form polyurethane prepolymer; b) then reacting above polyurethane prepolymer with a chain extender, if appropriate a chain terminator and further additives to form the polyurethane urea.

Polyurethane urea fiber having excellent elasticity is widely used the field of textile such as sport wear, general wear and stocking, non-textile such as hygiene articles. Diversified down-stream application imparts higher requirements on both comfort and appearance of elastic fabrics. On one hand, lower modulus, higher elongation and higher elastic recovery are required to make the elastic fabric easier to stretch and less restriction generated to the body. On the other hand, excellent heat-resistance is required as well since polyurethane urea fiber needs to interweave, dye and style with polyester, nylon, cotton, etc., in which the dyeing temperature of polyester is about 130° C. and the dry style temperature is above 160° C. The functionality and aesthetics of the fabric prepared from polyurethane urea fiber could be impacted if the heat-resistance of polyurethane urea fiber is not high enough.

U.S. Pat. No. 5,000,899A discloses a low modulus polyurethane urea fiber using copolymer glycol of tetrahydrofuran and 3-methyl tetrahydrofuran as the soft segment of the materials, which improves the fiber heat-setting properties. However, the heat-resistance of said fiber is sacrificed.

US20070117951A discloses the low modulus spandex prepared from the copolymer of tetrahydrofuran with high molecular weight and ethylene oxide, while, said spandex shows high residual deformation.

US20090182113A discloses the polyurethane urea produced via a) reacting polymeric glycol with a substance reactive therewith to form an OH-terminated prepolymer; b) reacting said OH-terminated prepolymer with a diisocyanate to form an isocyanate-terminated prepolymer; c) reacting said isocyanate-terminated prepolymer with a chain extender, and optionally chain terminator and additives to form the polyurethane urea; and d) spinning the polyurethane urea to form a fiber. However, the heat-resistance of said fiber is not disclosed.

CN101555634A discloses the method of enhancing the ratio of hard segment components 4,4′-methylenediphenyl diisocyanate (4,4′-MDI) or 1,2-ethylenediamine to improve the heat-resistance of the polyurethane urea fiber. CN1310991C discloses the method of introducing the polyols with aromatic functional groups to improve the heat-resistance of the polyurethane urea fiber. However, neither of them discloses the fibers with low modulus, in general the enhance of ratio of hard segment causes the decrease of elongation and increase of modulus. Furthermore, the enhance of ratio of hard segment also makes the solubility of polyurethane urea fiber decreased in the solvent of dimethylacetamide or dimethylformamide.

Therefore, there is a demand to provide polyurethane urea with low modulus, high elongation as well as good elastic recovery and heat-resistance.

### SUMMARY OF THE INVENTION

It is an object of the invention to provide a polyurethane urea with low modulus, high elongation as well as good elastic recovery and heat-resistance.

Another object of the present invention is to provide a process of producing polyurethane urea of the present invention from modified PolyTHF, diisocyanate, chain extender, chain terminator.

It has been surprisingly found that the above objects can be achieved by following embodiments:

### DETAILED DESCRIPTION OF THE INVENTION

Unless defined otherwise, all technical and scientific terms used herein have the meaning commonly understood by a person skilled in the art to which the invention belongs. As used herein, the following terms have the meanings ascribed to them below, unless specified otherwise.

The undefined article “a”, “an” and “the” mean one or more of the species designated by the term following said article.

m-PolyTHF, indicating modified PolyTHF, refers to the polyester alcohol deriving from the copolymerization of PolyTHF with dicarboxylic acid and/or their anhydrides and/or their esters.

Mn, indicating number average molecular weight in g/mol, which is tested according to ASTM E1899-2016.

Breaking elongation (De), indicating the stretch ratio upon breaking of the specimen.

Modulus, indicating the specimen stress at 300% stretch, in MPa.

Strength retention, indicating the stress retained by the specimen after heat treatment at 300% stretch compared to stress value before heat treatment at 300% stretch.

Rate of elastic recovery (RER %): the recovered stretch ratio of the specimen after repeated stretch.

Energy loss factor (b5), the energy loss of the specimen after repeated stretch to 300% elongation.

In the context of the present disclosure, any specific values mentioned for a feature (comprising the specific values mentioned in a range as the end point) can be recombined to form a new range.

Further embodiments of the present invention are discernible from the claims, the description, and the examples. It will be understood that and hereinbelow still to be elucidated features of the subject matter of the present invention are utilizable not only in the combination indicated, but also in other combinations without leaving the realm of the present invention.

One aspect of the present invention is directed to a polyurethane urea, wherein the De thereof is higher than 500%, modulus thereof is less than 10 MPa, strength retention thereof is higher than 80%, RER % thereof is higher than 85%, and b5 thereof is less than 15.

In a preferred embodiment, De of the polyurethane urea in the present invention is higher than 650%, preferably higher than 700%, more preferably higher than 750%.

In a preferred embodiment, modulus of the polyurethane urea in the present invention is less than 9 MPa, preferably less than 8 MPa, more preferably less than 7.5 MPa.

In a preferred embodiment, the strength retention of the polyurethane urea in the present invention is higher than 85%, preferably higher than 90%.

In a preferred embodiment, RER % of the polyurethane urea in the present invention is higher than 90%.

In a preferred embodiment, b5 of the polyurethane urea in the present invention is less than 13, preferably less than 12.

One embodiment of the present invention is directed to a process for producing a polyurethane urea in the present invention, which comprises:
a) reacting m-PolyTHF and diisocyanate to obtain a prepolymer.
b) adding chain extender and optionally chain terminator into said prepolymer to obtain a polyurethane urea solution.
c) spinning or casting the solution obtained in step b) to obtain the polyurethane urea.

In one embodiment, m-PolyTHF used in the present invention could be prepared according to the method disclosed in US2012/0059142A1. More specifically, the m-PolyTHFs are prepared based on polytetrahydrofuran and dicarboxylic acid and/or their anhydrides and/or their esters.

In a preferred embodiment, the m-PolyTHFs are prepared based on polytetrahydrofuran and aromatic dicarboxylic acids and/or their anhydrides and/or their esters. Preferably said aromatic dicarboxylic acids are selected from isophthalic acid, phthalic acid, terephthalic acid and mixture thereof; more preferably said aromatic dicarboxylic acid is isophthalic acid.

Mn of the m-PolyTHF used in the present invention is preferably in the range from 2000 to 4000 g/mol, preferably 2000 to 3500 g/mol.

Mn of polytetrahydrofuran used to prepare m-PolyTHF in the present invention is preferably in the range from 200 to 2000 g/mol, more preferably 200 to 1800 g/mol, most preferably 200 to 1500 g/mol.

The diisocyanate used in above step a) can be any desired organic diisocyanate. Preferred diisocyanate include linear aliphatic isocyanates, such as 1,2-ethylene diisocyanate, 1,3-propylene diisocyanate, 1,4-butylene diisocyanate, 1,6-hexamethylene diisocyanate, 1,8-octamethylene diisocyanate, 1,5-diisocyanato-2,2,4-trimethylpentane, 3-oxo-1,5-pentane diisocyanate and or mixture thereof; cycloaliphatic diisocyanates, such as isophorone diisocyanate, cyclohexane diisocyanates or mixture thereof, preferably 1,4-cyclohexane diisocyanate, 4,4′-diisocyanato-dicyclohexylmethane (HMDI); and aromatic diisocyanates, such as 2,2′-, 2,4′- and 4,4′-diphenylmethane diisocyanate, the mixtures of various monomeric diphenylmethane diisocyanates, 2,4- or 2,6-tolylene diisocyanate (TDI) or mixtures thereof, naphthylene diisocyanate (NDI) or mixtures thereof. Particularly preferred diisocyanates are 4,4′-MDI, and 2,4- or 2,6-tolylene diisocyanate, preferred is 4,4′-MDI.

In another embodiment, the diisocyanate used in step a) are used in excess. Preferably the mole ratio of m-PolyTHF to diisocyanate is in the range from 1:1.2 to 1:3, more preferably 1:1.3 to 1:2. The reaction is initiated by mixing m-PolyTHF and diisocyanate at temperatures of 20 to 120° C., preferably 50 to 100° C., more preferably 70 to 90° C. The reaction is preferably carried out without solvent. When a solvent is used, preferably the solvent is a polar aprotic solvent such as N, N-dimethylacetamide or N, N-dimethylformamide. This reaction preferably proceeds without catalyst. When a catalyst is used, phosphoric acid for example may be used at a concentration of preferably 50 to 200 ppm, based on the reaction mixture.

Useful chain extenders include compounds having two isocyanate-reactive hydrogen atoms and a molecular weight of less than 500 g/mol. There may be used for example ethylenediamine, 1,2-propylenediamine, 1,3-propylenediamine, 1,4-butanediamine, 1,5-diaminopentane, hydrazine, m-xylylenediamine, p-xylylenediamine, 1,4-cyclohexanediamine, 1,3-cyclohexanediamine, 1,3-diamine-4-methylcyclohexane, 1-amino-3-aminoethyl-3,5,5-trimethylcyclohexane (isophoronediamine), 1,1′-methylenebis(4,4′-diamino-hexane), toluene diamine, piperazine, ethylene glycol, 1,2-propanediol, 1,3-propanediol, 1,4-butanediol, 1,5-pentanediol, 1,6-hexanediol or mixtures thereof. Particular preference is given to diamines, such as ethylenediamine, 1,2-propylenediamine, 1,3-propylenediamine, 1,4-butanediamine, 1,5-diaminopentane, hydrazine, m-xylylenediamine, p-xylylenediamine, 1,4-cyclohexanediamine, 1,3-cyclohexane-diamine, 1,3-diamine-4-methylcyclohexane, 1-amino-3-aminoethyl-3,5,5-trimethylcyclohexane (isophoronediamine), 1,1′-methylenebis(4,4′-diaminohexane) and mixtures thereof, in particular preference is given to ethylenediamine, 1,2-propylenediamine and mixtures thereof.

In a preferred embodiment, the chain extender in the present invention further comprises aromatic diamine as co-chain extender, wherein said aromatic diamine having two hydrogen atoms reactive with isocyanate group; preferably said aromatic diamine are selected from toluene diamine, 1,3-m-phenylenediamine, 1,4-p-phenylenediamine, 4,4′-diphenylmethane diamine, 2,2-bis(4-aminophenyl) propane, 4,4′-diaminobenzene sulfone, 1,4-naphthalenediamine, 1,5-naphthalenediamine, 1,6-naphthalenediamine or mixture thereof. The mole ratio of aromatic diamine to aliphatic diamine is 2:98 to 50:50, preferably 2:98 to 40:60, more preferably 5:95 to 30:70, most preferably 10:90 t0 25:75.

In further embodiment, useful chain terminators include for example secondary amines, such as dimethylamine, dibutyl amine, dicyclohexylamine; or primary amines, such as ethanolamine, or primary alcohols, such as n-butanol, alone or as mixtures. Preferably the chain terminator is a monofunctional amine.

In the embodiments, specific amines are optionally used, examples being diethylene-triamine or diethanolamine to the level not impacting the smoothing production.

When a chain terminator and/or a specific amine is or used as well as chain extender, the fraction of chain-extending agent or agents is preferably 85% by weight or more and more preferably 90% by weight or more, based on the total weight of chain extender, chain terminator and specific amine.

These chain terminators and the specific amines may each be used individually or together with the chain extenders. Individually means that the components can be added simultaneously in various streams or at different times.

The ratio of isocyanate groups to amine groups is preferably in the range from 1:1 to 1:1.15, more preferably from 1:1 to 1:1.05.

The conversion of the prepolymer to the polyurethane urea of the present invention preferably takes place in solution. Polar aprotic solvents can be used. A polar aprotic solvent is a solvent which dissolves the prepolymer but is essentially unreactive with isocyanate groups. Examples of such solvents are N, N-dimethylacetamide, N, N-dimethylformamide, dimethyl sulfoxide, N-methyl pyrrolidone or the like. Preference is given to using N, N-dimethylacetamide or N, N-dimethylformamide, particular preference is given to using N, N-dimethylacetamide. Preferably, the prepolymer, the chain extenders, if appropriate the chain terminators and if appropriate the specific amines are in each case dissolved in the solvent and the solutions obtained are subsequently mixed with one another. Preferably, the respective solutions are added separately to the solution of the prepolymer. This can take place concurrently or at different times. Alternatively, the solutions of chain extender, chain terminators and specific amine can be mixed prior to addition to the prepolymer. The temperature at which the reaction takes place is preferably in the range from 0 to 80° C., more preferably from 8 to 50° C., most preferably from 10 to 35° C. Customarily, all isocyanate-reactive materials are used in such an amount that there is a small excess of isocyanate-reactive groups, generally amino groups.

The fully reacted solution is subsequently spun to form a fiber. Any spinning process whereby a fiber in accordance with the present invention can be produced can be used. Such spinning processes are described for example in “Kunststoffhandbuch, 7, Polyurethane”, Carl Hanser Verlag, 3rd edition 1993, Chapter 13.2. These include dry-spinning or wet-spinning processes, preferably the dry-spinning process. In the spinning process, a spinning solution comprising the polyurethane urea of the present invention is spun through a spinneret die to form threads. Removing the spinning solvent, for example by drying or in a coagulation bath, gives the polyurethane urea fibers of the present invention.

The polyurethane urea of the present invention may further comprise additives. Any additives known for segmented polyurethane urea fibers can be used herein. For example, delusterants, fillers, antioxidants, dyes, pigments, dye enhancers, for example Methacrol 2462 B, and stabilizers against heat, light, UV radiation, chlorinated water and against the action of gas fumes and air pollution such as NO or NO₂ may be included. Examples of antioxidants, stabilizers against heat, light or UV radiation are stabilizers from the group of the sterically hindered phenols, for example Cyanox 1790, hindered amine light stabilizers, triazines, benzophenones and benzotriazoles. Examples of pigments and delusterants are titanium dioxide, magnesium stearate, silicone oil, zinc oxide and barium sulfate. Examples of dyes are acidic dyes, disperse dyes and pigments and optical brighteners. Examples of stabilizers against fiber degradation by chlorine or chlorinated water are zinc oxide, magnesium oxide, or coated or uncoated magnesium aluminum hydroxycarbonates, for example hydrotalcites or huntites.

A polyurethane urea in accordance with the present invention has advantageous properties regarding De, modulus, strength retention, elastic recovery and energy loss. These advantageous properties are characterized using solution-cast polyurethane urea films. These are obtainable by casting the polyurethane urea solution onto a planer surface and removing the solvent by drying.

The polyurethane urea of the present invention is useful for producing spandex fibers for elastic textiles, for example woven, knits and other textile goods.

Preferably, the viscosity of polyurethane urea of the present invention spinning fluid is 120,000 to 500,000 mPa·s and increase rate of viscosity thereof is less than 5,000 mPa·s/h.

The examples which follow further illustrate the invention.

In the present invention, the test methods of various properties are as following:

For handling and reproducibility reasons, the mechanical properties of the polyurethane urea were measured on films. To this end, a solution of the polyurethane urea prepared was converted to a film by casting the solution onto a precisely horizontally aligned glass plate and allowing it to dry at 50° C. in a slow N₂ stream. Amount and concentration of the solution as well as the plate area were matched to each other to produce a film about 0.20 to 0.26 mm in thickness.

The trends observed in films are essentially in line with those for the fibers, effects of polymer chain orientation seen in fibers and imparted by the spinning process are not reflected in film. Such differences do not impede the spirit of the present invention.

De: take the standard shape and size film sample of polyurethane urea according to ISO37:2005, change in length of the extended sample, expressed as % of the original length, at which the sample breaks.

Modulus: take the standard shape and size film sample of polyurethane urea according to ISO37:2005, test the stress of the sample under 300% elongation according to ISO37:2005 with a unit of MPa.

Strength retention: take the standard membrane sample of polyurethane urea according to ISO37:2005, put it into the oven under 175° C. for 10 minutes, test the 300% elongation stress according to ISO37:2005, strength retention %=(300% elongation stress after heat treatment/300% elongation stress before heat treatment)*100.

RER %: take the standard shape and size film sample of polyurethane urea according to ISO37:2005, stretch the sample for 5 times to 300% elongation and then test the length of the sample thereafter according to DIN53835-2:1981. RER %=(1−(the fifth recovery length of 300% elongation−initiate length)/(the 300% elongation length−initiate length))*100.

b5: take the standard shape and size film sample of polyurethane urea according to ISO37:2005, stretch the sample for 5 times to 300% elongation according to DIN53835-2:1981. b5=(the first 300% Elongation Stress−the fifth 300% Elongation Stress)/the first 300% Elongation Stress*100.

### EXAMPLES

### Materials Used in Examples

Lupranate® M: MDI from BASF
DDM: 4,4′-diaminodiphenylmethane from BASF
DMAC: dimethylacetamide from SINOPHARM
EDA: 1,2-ethylenediamine from BASF
DEA: diethyl amine from BASF
PPD: 1,4-p-phenylenediamine from Sigma-Aldrich
Irgonox® 245: CAS 36443-68-2 from BASF
Tinuvin® 622: CAS 70198-29-7 from BASF
   m-PolyTHF: Modified PolyTHF® Based on the Following Procedure

m-PolyTHF-1 is the m-PolyTHF prepared according to the procedure in Example 1 of US2012/0059143. 857 parts PolyTHF® 650 were reacted with 166 parts of isophthalic acid under catalysis of 20 ppm by weight of tetrabutyl orthotitanate to PolyTHF® 650 by gradually increasing temperature to 220° C. and reducing pressure to 20 mbar. When the acid number reaches 1 mgKOH/g or less, the temperature was cooled to 200° C., 20 ppm of 85% by weight of phosphoric acid were charged, then further cooled down, the resulting m-PolyTHF-1 has a OH number of 36 mgKOH/g. m-PolyTHF-2 and m-PolyTHF-3 were prepared according to the same procedures as described above in m-PolyTHF-1, the number average molecular weight of starting PolyTHF® Mn and corresponding m-PolyTHF Mn are summarized in table 1, both of which were tested according to ASTM E1899-2016.

TABLE 1
m-PolyTHFs material information

| | Mn | Mn |
|---|---|---|
| | PolyTHF ®(g/mol) | m-PolyTHF(g/mol) |
| m-PolyTHF-1 | 650 | 3100 |
| m-PolyTHF-2 | 1000 | 3100 |
| m-PolyTHF-3 | 650 | 2500 |

### Example 1

200.00 parts by weight m-PolyTHF-1 and 27.42 parts by weight Lupranate® M were charged in to the N₂ purged reactor and reacted for 120 min under 80° C. to generate the prepolymer with NCO % content of 1.66% by weight; the temperature was decreased to below 50° C. and the prepolymer generated was dissolved with 277.95 parts by weight DMAC (referred to as DMAC-1 in table 2). To this diluted prepolymer solution, a solution of 2.27 parts by weight EDA, 0.45 parts by weight PPD, 0.72 parts by weight DEA and 156.49 parts by weight DMAC (referred to as DMAC-2 in table 2) were charged by high-speed mixing to get a homogeneous polyurethane urea solution. Additive of 0.2% (by weight of polyurethane urea, hereinafter the same) heat stabilizer Irgonox® 245 and 0.1% ultraviolet stabilizer Tinuvin® 622 were added into the dope of polyurethane urea solution to obtain the polyurethane urea spinning solution. The relevant properties of obtained spinning solution were tested with cast film, wherein the film thickness was controlled within 200±30 um, hereinafter the same.

### Example 2-6 and Comparative 1

The polyurethane urea films were prepared in the similar manner as in Example 1, except for using the respective raw materials and amounts thereof as illustrated in Table 2. The properties of the polyurethane urea film thus obtained were tested according to the methods as described above and the measured results are summarized in Table 3.

TABLE 2
Raw material feeding in Examples 1-6 and Comparative 1

| | | m-PolyTHF | m-PolyTHF | MDI | EDA | Co-CE | DEA | DMAC-1 | DMAC-2 |
|---|---|---|---|---|---|---|---|---|---|
| | Co-CE | type | parts | parts | parts | parts | parts | parts | parts |
| Example-1 | PPD | 1 | 200.00 | 27.42 | 2.27 | 0.45 | 0.72 | 277.95 | 156.49 |
| Example-2 | PPD | 2 | 200.00 | 27.44 | 2.03 | 0.91 | 0.63 | 277.99 | 156.75 |
| Example-3 | PPD | 3 | 200.00 | 31.01 | 2.05 | 0.92 | 0.63 | 282.34 | 159.17 |
| Example-4 | DDM | 2 | 200.00 | 27.42 | 2.28 | 0.84 | 0.63 | 277.95 | 157.05 |
| Example-5 | DDM | 2 | 200.00 | 27.42 | 2.03 | 1.67 | 0.63 | 277.95 | 158.15 |
| Example-6 | DDM | 2 | 200.00 | 27.42 | 1.77 | 2.51 | 0.63 | 277.95 | 159.25 |
| Comparative-1 | * | 2 | 200.00 | 34.29 | 4.25 | 0.00 | 0.70 | 286.35 | 163.85 |

### REMARKS

Co-CE stands for Co-chain extender
m-PolyTHF type: 1 for m-PolyTHF-1, 2 for m-PolyTHF-2, 3 for m-PolyTHF-3, as depicted in Table 1.

TABLE 3
The film performance test result
of Examples 1-6 and Comparative 1

| | | | Strength | | |
|---|---|---|---|---|---|
| | De/% | Modulus/MPa | retention/% | RER % | b5 |
| Example-1 | 736 | 7.20 | 92 | 93 | 9.8 |
| Example-2 | 785 | 7.17 | 91 | 94 | 10.5 |
| Example-3 | 790 | 7.14 | 90 | 93 | 11.1 |
| Example-4 | 703 | 7.10 | 91 | 92 | 10.7 |
| Example-5 | 659 | 6.90 | 91 | 91 | 11.3 |
| Example-6 | 678 | 7.30 | 92 | 90 | 13.7 |
| Comparative -1 | 645 | 9.50 | 87 | 86 | 15.3 |

1. A polyurethane urea, wherein the breaking elongation (De) thereof is higher than 500%, modulus thereof is less than 10 MPa, strength retention thereof is higher than 80%, rate of elastic recovery RER % thereof is above 85%, energy loss factor (b5) thereof is less than 15, wherein De, modulus and strength retention of said polyurethane urea are tested according to ISO37:2005.

2. The polyurethane urea according to claim 1, wherein De of the polyurethane urea is higher than 650%.

3. The polyurethane urea according to claim 1, wherein the modulus of said polyurethane urea is less than 9 MPa.

4. The polyurethane urea according to claim 1, wherein strength retention of said polyurethane urea is higher than 85%.

5. The polyurethane urea according to claim 1, wherein RER % of said polyurethane urea is higher than 90%.

6. The polyurethane urea according to claim 1, wherein the energy loss factor (b5) of said polyurethane urea is less than 13.

7. A process for producing the polyurethane urea according to claim 1, comprising:
a) reacting m-PolyTHF and diisocyanate to obtain a prepolymer,
b) adding a chain extender and optionally a chain terminator into said prepolymer to obtain a polyurethane urea spinning solution,
c) spinning or casting the solution obtained in b) to obtain the polyurethane urea.

8. The process according to claim 7, wherein the m-PolyTHF used in a) is obtained from condensation of polytetrahydrofuran with a dicarboxylic acid and/or their anhydrides and/or their esters.

9. The process according to claim 8, wherein a number-average molecular weight (Mn) of the polytetrahydrofuran is 200 to 2000 g/mol.

10. The process according to claim 7, wherein the Mn of m-PolyTHF is 2000 to 4000 g/mol.

11. The process according to claim 7, wherein the diisocyanate used in a) comprises 4,4′-diisocyanate.

12. The process according to claim 7, wherein a mole ratio of m-PolyTHF and diisocyanate is 1:1 to 1:3.

13. The process according to claim 7, wherein the chain extender comprises an aliphatic diamine having two hydrogen atoms reactive with an isocyanate group.

14. The process according to claim 7, wherein the chain extender comprises aromatic diamine, said aromatic diamine having two hydrogen atoms reactive with isocyanate group.

15. The process according to claim 7, wherein a mole ratio of aromatic diamine to aliphatic diamine in the chain extender is 2:98 to 50:50.

16. The process according to claim 7, wherein the chain terminator is alkyl alcohol and/or diallyl amine.

17. The process according to claim 7, wherein the m-PolyTHF used in a) is obtained from condensation of polytetrahydrofuran with an aromatic dicarboxylic acid.

18. The process according to claim 7, wherein the diisocyanate used in a) comprises more than 60% 4,4′-diisocyanate.

19. The process according to claim 7, wherein the chain extender comprises at least one aliphatic diamine selected from the group consisting of 1,2-ethylenediamine, 1,2-propylenediamine, 1,3-propylenediamine, 1,4-butanediamine, 1,5-pentane diamine, 1,4-cyclohexanediamine and mixtures thereof.

20. The process according to claim 7, wherein the chain extender comprises at least one aromatic diamine selected from the group consisting of 1,4-benzene dimethylamine, toluene diamine, 1,3-m-phenylenediamine, 1,4-p-phenylenediamine, 4,4′-diphenylmethanediamine, 2,2-bis(4-aminophenyl) propane, 4,4′-diaminobenzene sulfone, 1,4-naphthalenediamine, 1,5-naphthalenediamine, 1,6-naphthalenediamine and mixtures thereof.
